(19) United States
(12) Patent Application Publication
(10) Pub. No.: US 2008/0178840 A1
(43) Pub. Date: Jul. 31, 2008

(54) Electronic control throttle system for a vehicle and vehicle equipped therewith

(75) Inventors: Takeru Oshima, Kobe-shi (JP); Satoru Sakanaka, Akashi-shi (JP); Takuya Sakamoto, Akashi-shi (JP); Tatsuya Hirokami, Osaka-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: Kawasaki Jukogyo Kabushiki Kaisha, Kobe-shi (JP)

(21) Appl. No.: 12/011,691

(22) Filed: Jan. 28, 2008

(30) Foreign Application Priority Data
Jan. 29, 2007 (JP) 2007-018079

(51) Int. Cl. F02D 9/00

(52) U.S. Cl. 123/349

(57) ABSTRACT

An electronic control throttle system for a vehicle, comprising a hand-operated-shaft-side driven member configured to operate in association with rotation of a hand-operated shaft, the hand-operated-shaft-side driven member having a supported portion; a throttle-shaft-side driven member which is provided to operate in association with rotation of a throttle shaft, the throttle-shaft-side driven member having a support portion positioned in a direction to close the throttle valve relative to the supported portion on an operation track of the supported portion; an actuator configured to cause the throttle shaft to rotate to open and close the throttle valve; and a controller having an automated cruise mode in which the hand-operated shaft is subjected to a force in the direction to close the throttle valve and the supported portion is supported in contact with the support portion to cause the hand-operated shaft to operate according to the rotation of the throttle shaft.

### TECHNICAL FIELD

The present invention relates to an electronic control throttle system having an automated cruise mode in which an actuator is controlled by a controller to open and close a throttle valve so that a vehicle speed of a vehicle is maintained automatically, and a vehicle equipped with the electronic control throttle system.

### BACKGROUND ART

For motorcycles, there has been proposed a control system having an automated cruise mode in which a motor controlled by an ECU controls an opening degree of a throttle valve for changing an amount of air taken in from outside and supplied to an engine, and a vehicle speed of the motorcycle is maintained without depending on a throttle grip operation performed by a driver (e.g., see Japanese Laid-Open Patent Application Publication No. 2001-246960). The automated cruise mode makes it possible to reduce an operation burden on a driver and to inhibit reduction of fuel efficiency caused by a change in the vehicle speed of the motorcycle, in contrast to a normal mode in which the driver operates the throttle grip with a hand.

In the control system disclosed in Japanese Laid-Open Patent Application Publication No. 2001-246960, a throttle shaft of the throttle valve is mechanically coupled to the throttle grip and the motor. In this construction, since the throttle grip operation performed by the driver is directly transmitted to the throttle shaft in the normal mode, an air-intake amount does not fluctuate smoothly, making the driver feel discomfort in driving the motorcycle. Also, when the driver quickly operates the throttle grip to close the throttle valve, an optimal combustion balance cannot be kept because of deficiency of the air-intake amount, degrading gas exhausting performance.

Accordingly, Japanese Laid-Open Patent Application Publication No. 2003-328784 discloses an electronic control throttle system in which a throttle grip is not mechanically coupled to a throttle shaft, and, in the normal mode, a throttle valve is driven to open and close by a motor under control of an ECU, based on an amount of rotation of the throttle grip, which is detected by a grip position sensor. In accordance with this electronic control throttle system, an optimal target opening degree of the throttle valve is calculated depending on a driving state of the motorcycle, and an electronic control is executed so that a deviation between a throttle valve opening degree resulting from the hand operation performed by the driver and the target opening degree is reduced. As a result, an optimal air-intake state can be maintained.

Assuming that the automated cruise mode is incorporated into the electronic control throttle system, the throttle grip is returned to a fully closed position by a force applied by a spring in a direction to close the throttle valve in the automated cruise mode, because the throttle grip is coupled to the throttle shaft electrically rather than mechanically. In the automated cruise mode, if the driver operates the throttle grip to open the throttle valve when the throttle grip is in the fully closed position, the automated cruise mode is maintained until a resulting grip opening degree reaches a grip opening degree corresponding to the cruising speed of the automated cruise. When the driver operates the throttle grip to open the throttle valve beyond the grip opening degree corresponding to the cruising speed in the automated cruise mode, the automated cruise mode returns to the normal mode, in which state, acceleration for reaching or surpassing the cruising speed can be carried out by the driver's hand operation.

Since there is a significant difference (dead zone or band) between the grip opening degree (fully closed position) at which the driver starts rotating the throttle grip and the grip opening degree at which acceleration actually occurs, the acceleration starts with a large time lag after the driver has operated the throttle grip to open the throttle valve. As a result, the driver feels discomfort in driving the motorcycle.

### SUMMARY OF THE INVENTION

The present invention addresses the above described conditions, and an object of the present invention is to provide an electronic control throttle system for a vehicle which is capable of reducing discomfort associated with acceleration resulting from a driver's operation in an automated cruise mode, and a vehicle equipped with the electronic control throttle system.

According to an aspect of the present invention, there is provided an electronic control throttle system for a vehicle, comprising a throttle shaft configured to rotate a throttle valve for substantially opening and closing an air-intake passage connected to an engine; a hand-operated shaft configured to rotate in association with a rotation of an input member configured to be operated by a driver driving the vehicle; a biasing mechanism configured to apply a force to rotate the hand-operated shaft in a direction to close the throttle valve; a hand-operated-shaft-side driven member configured to operate in association with the rotation of the hand-operated shaft, the hand-operated-shaft-side driven member having a supported portion; a throttle-shaft-side driven member which is provided to operate in association with the rotation of the throttle shaft, the throttle-shaft-side driven member having a support portion positioned in a direction to close the throttle valve relative to the supported portion on an operation track of the supported portion; an actuator configured to cause the throttle shaft to rotate to open and close the throttle valve; and a controller having an automated cruise mode for controlling the actuator to control an engine speed of the engine so that a travel speed of the vehicle becomes a preset cruising speed; wherein in the automated cruise mode, the hand-operated shaft is subjected to a force in the direction to close the throttle valve and the supported portion is supported in contact with the support portion to cause the hand-operated shaft to operate according to the rotation of the throttle shaft.

In accordance with such a configuration, when the hand-operated shaft is subjected to the force in the direction to close the throttle valve in the automated cruise mode, the supported portion of the hand-operated-shaft-side driven member is supported in contact with the support portion of the throttle-shaft-side driven member. Thereby, the rotation of the throttle shaft driven by the actuator is transmitted to the hand-operated shaft via the throttle-shaft-side driven member and the hand-operated-shaft-side driven member. So, the input member operable in association with the hand-operated shaft rotates according to the rotation of the throttle shaft. Thereby, when the driver operates the input member in the automated cruise mode, the driver need not start operating the input member from a fully closed position. That is, the difference in opening degree between the position at which the driver starts operating the input member and the position at which acceleration actually starts is significantly reduced. This makes it possible to reduce or avoid a large time lag during acceleration when the input member has been operated to open the throttle valve in the automated cruise mode. As a result, responsiveness of the vehicle to the operation of the input member is improved, improving the driver's comfort.

The electronic control throttle system may further comprise a position sensor configured to detect a rotational angle of the hand-operated shaft; and an opening detector configured to detect that the input member has been operated in a direction to open the throttle valve from a position corresponding to the cruising speed in the automated cruise mode. The controller has a normal mode for controlling the actuator based on a detected value of the position sensor, and is configured to, in the automated cruise mode, switch the automated cruise mode to the normal mode when the opening detector detects that the input member has been operated in the direction to open the throttle valve from the position corresponding to the cruising speed in the automated cruise mode.

In such a configuration, the opening detector is provided to detect that the input member has been operated in the direction to open the throttle valve from the position corresponding to the cruising speed in the automated cruise mode, and the controller switches the automated cruise mode to the normal mode based on a detection signal from the opening detector, and controls acceleration. This makes it possible to improve the responsiveness of the vehicle to the operation of the input member operable according to the cruising speed in the automated cruise mode.

The electronic control throttle system may further comprise a throttle opening degree detector configured to detect a rotational angle of the throttle shaft. The controller may include the opening detector. The opening detector may be configured to, in the automated cruise mode, determine that the input member has been operated in the direction to open the throttle valve from the position corresponding to the cruising speed, based on the rotational angle detected by the position sensor and the rotational angle detected by the throttle opening degree detector.

In such a configuration, the controller is able to easily detect that the input member has been operated in the direction to open the throttle valve from the position corresponding to the cruising speed, without additionally providing an opening sensor for exclusive use.

The opening detector may be configured to, in the automated cruise mode, determine that the input member has been operated in the direction to open the throttle valve from the position corresponding to the cruising speed, when the rotational angle detected by the position sensor is a predetermined value or greater than the rotational angle detected by the throttle opening degree detector.

In such a configuration, the controller is able to easily detect that the input member has been operated in the direction to open the throttle valve from the position corresponding to the cruising speed.

The electronic control throttle system may further comprise a position sensor configured to detect a rotational angle of the hand-operated shaft. The controller may have a normal mode for controlling the actuator based on a detected value of the position sensor. In the normal mode, the supported portion of the hand-operated-shaft-side driven member may be provided to form a clearance in the direction to close the throttle valve relative to the support portion of the throttle-shaft-side driven member, between the supported portion and the support portion.

In such a configuration, in the normal mode, the supported portion of the hand-operated-shaft-side driven member is not in contact with the support portion of the throttle-shaft-side driven member, but there is a clearance between them. So, if the input member is quickly operated in the direction to close the throttle valve in the normal mode, the operation of hand-operated-shaft-side driven member in the direction to close the throttle valve is not impeded by the throttle-shaft-side driven member. Therefore, if the throttle shaft rotates after a slight time lag after the hand-operated shaft has been rotated in a case where the throttle shaft is controlled to be rotated according to the amount of the rotation of the hand-operated shaft in the normal mode, the hand-operated-shaft-side driven member does not interfere with the throttle-shaft-side driven member. This makes it possible to reduce or avoid driver discomfort while operating the input member.

The electronic control throttle system may further comprise a position sensor configured to detect a rotational angle of the hand-operated shaft and a closing operation detector configured to detect that the input member has been operated in the direction to close the throttle valve in the automated cruise mode. The controller may have a normal mode for controlling the actuator based on a detected value of the position sensor. The controller may be configured to switch the automated cruise mode to the normal mode when the closing operation detector detects that the input member has been operated in the direction to close the throttle valve.

In such a configuration, when the driver operates the input member to close the throttle shaft in the automated cruise mode, the automated cruise mode is forcibly terminated and switches to the normal mode. This improves response to the deceleration performed by the driver.

The closing operation detector may include a throttle cable through which the rotation of the input member is transmitted to the hand-operated shaft; a pivot lever to which the throttle cable is coupled; a detected member provided on the pivot lever; a closing sensor having a detecting portion in a position where a distance between the detecting portion and the detected member is changed according to a pivot amount of the pivot lever, the closing sensor being configured to change an output signal according to the distance between the detecting portion and the detected member. The closing operation detector is configured to detect that the input member has been operated in the direction to close the throttle valve, based on the output signal from the closing sensor. Alternatively, the electronic control throttle system may further comprise a tension sensor configured to detect a tension of a throttle cable through which the input member and the hand-operated shaft are coupled to each other. The closing operation detector may be configured to detect that the input member has been operated in the direction to close the throttle valve when the tension detected by the tension sensor is a predetermined value or more.

The hand-operated shaft and the throttle shaft may be disposed coaxially.

In such a configuration, since the hand-operated shaft and the throttle shaft are arranged along a common axis, there is a space in a direction perpendicular to the common axis. As a result, the electronic control throttle system can be made compact.

The hand-operated-shaft-side driven member may be coupled integrally with the hand-operated shaft. Also, the throttle-shaft-side driven member may be coupled integrally with the throttle shaft.

In such a configuration, components or members may be omitted between the hand-operated-shaft-side driven member and the hand-operated shaft and between the throttle-shaft-side driven member and the throttle shaft. As a result, the number of components does not substantially increase.

The hand-operated-shaft-side driven member may be provided at an end portion of the hand-operated shaft and has a disc shape which is coaxial with a rotation center of the hand-operated shaft, and the throttle-shaft-side driven member may be provided at an end portion of the throttle shaft and has a disc shape which is coaxial with rotation centers of the throttle shaft and the hand-operated-shaft-side driven member. The hand-operated-shaft-side driven member and the throttle-shaft-side driven member may be disposed to face each other to be spaced apart from each other.

In such a configuration, since the hand-operated-shaft-side driven member and the throttle-shaft-side driven member are respectively rotatable around the corresponding shafts, an operation range of the support portion and the supported portion provided at the driven members can be reduced.

The support portion may protrude from the throttle-shaft-side driven member toward the hand-operated-shaft-side driven member, and the supported portion may protrude from the hand-operated-shaft-side driven member toward the throttle-shaft-side driven member and is positioned in a space which is located in a direction to open the throttle valve relative to the support portion. In such a configuration, a simple support structure is obtained.

The hand-operated-shaft-side driven member and the throttle-shaft-side driven member may have a substantially equal diameter. The support portion and the supported portion may be provided at outer peripheral portions of the throttle-shaft-side driven member and the hand-operated-shaft-side driven member, respectively. One of the support portion and the supported portion may extend to a location opposite to an outer peripheral surface of the throttle-shaft-side driven member or the hand-operated-shaft-side driven member at which the other of the support portion and the supported portion is provided. In such a configuration, a simple support structure is obtained.

The support portion of the throttle-shaft-side driven member may be provided in a position except for a space which is located in a direction to open the throttle valve relative to the supported portion of the hand-operated-shaft-side driven member. In such a configuration, the support portion does not interfere with the supported portion even when the throttle valve is quickly opened in the normal mode.

According to another aspect of the present invention, there is provided a vehicle equipped with an electronic control throttle system, the electronic control throttle system including a throttle shaft configured to rotate a throttle valve for substantially opening and closing an air-intake passage connected to an engine; a hand-operated shaft configured to rotate in association with a rotation of an input member configured to be operated by a driver driving the vehicle; a biasing mechanism configured to apply a force to rotate the hand-operated shaft in a direction to close the throttle valve; a hand-operated-shaft-side driven member configured to operate in association with the rotation of the hand-operated shaft, the hand-operated-shaft-side driven member having a supported portion; a throttle-shaft-side driven member which is provided to operate in association with the rotation of the throttle shaft, the throttle-shaft-side driven member having a support portion positioned in a direction to close the throttle valve relative to the supported portion on an operation track of the supported portion; an actuator configured to cause the throttle shaft to rotate to open and close the throttle valve; and a controller having an automated cruise mode for controlling the actuator to control an engine speed of the engine so that a travel speed of the engine becomes a preset cruising speed; wherein in the automated cruise mode, the hand-operated shaft is subjected to a force in the direction to close the throttle valve and the supported portion is supported in contact with the support portion to cause the hand-operated shaft to operate according to the rotation of the throttle shaft. In such a configuration, responsiveness of the vehicle to the operation of the input member is improved, improving the driver's comfort.

The input member may be a throttle grip or a throttle lever configured to be gripped by a driver driving the vehicle. In such a configuration, since the driver grips the input member all the time during travel of the vehicle, transition from the automated cruise mode to the normal mode is quickly accomplished.

The above and further objects and features of the invention will more fully be apparent from the following detailed description and accompanying drawings.

### BRIEF DESCRIPTION OF THE DRAWINGS

FIG. 1 shows a left side view of a motorcycle according to a first embodiment of the present invention;

FIG. 2 shows a block diagram of an electronic control throttle system mounted in the motorcycle of FIG. 1;

FIG. 3A shows a front view of a throttle-shaft-side driven member of the electronic control throttle system of FIG. 2;

FIG. 3B shows a side view of the throttle-shaft-side driven member of the electronic control throttle system of FIG. 2;

FIG. 3C shows a perspective view of the throttle-shaft-side driven member of the electronic control throttle system of FIG. 2;

FIG. 4A shows a front view of a hand-operated-shaft-side driven member of the electronic control throttle system of FIG. 2;

FIG. 4B shows a side view of the hand-operated-shaft-side driven member of the electronic control throttle system of FIG. 2;

FIG. 4C shows a perspective view of the hand-operated-shaft-side driven member of the electronic control throttle system of FIG. 2;

FIG. 5 shows a side view showing a region surrounding a closing detecting switch of the electronic control throttle system of FIG. 2;

FIG. 6A shows a front view showing a positional relationship between the throttle-shaft-side driven member and the hand-operated-shaft-side driven member in a normal mode;

FIG. 6B shows a side view showing the positional relationship between the throttle-shaft-side driven member and the hand-operated-shaft-side driven member in the normal mode;

FIG. 6C shows a perspective view showing the positional relationship between the throttle-shaft-side driven member and the hand-operated-shaft-side driven member in the normal mode;

FIG. 7 shows a side view showing a positional relationship between the throttle-shaft-side driven member and the hand-operated-shaft-side driven member in an automated cruise mode;

FIG. 8 shows a flow chart showing an operation of the electronic control throttle system of FIG. 2;

FIG. 9 shows a block diagram showing components of an electronic control throttle system according to a second embodiment of the present invention;

FIG. 10 shows a block diagram showing an operation of the electronic control throttle system of FIG. 9;

FIG. 11 shows a perspective view showing components of an electronic control throttle system according to a third embodiment of the present invention; and

FIG. 12 shows a perspective view showing components of an electronic control throttle system according to a fourth embodiment of the present invention.

### DETAILED DESCRIPTION OF THE PREFERRED EMBODIMENTS

Hereinafter, embodiments of the present invention will be described with reference to the accompanying drawings. Herein, directions are generally referenced from the perspective of a driver mounting a motorcycle.

### Embodiment 1

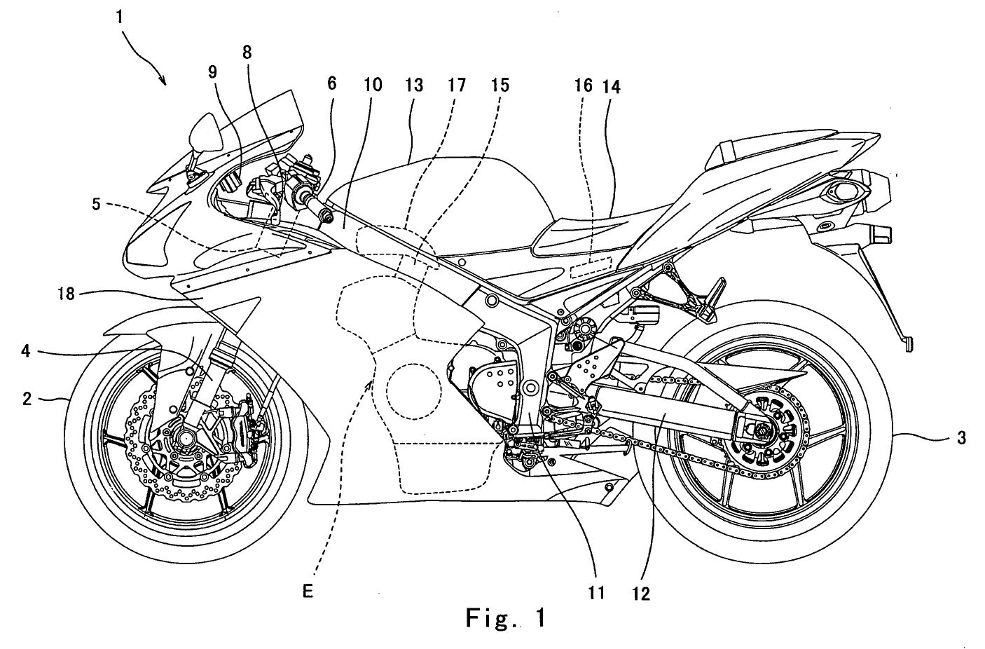

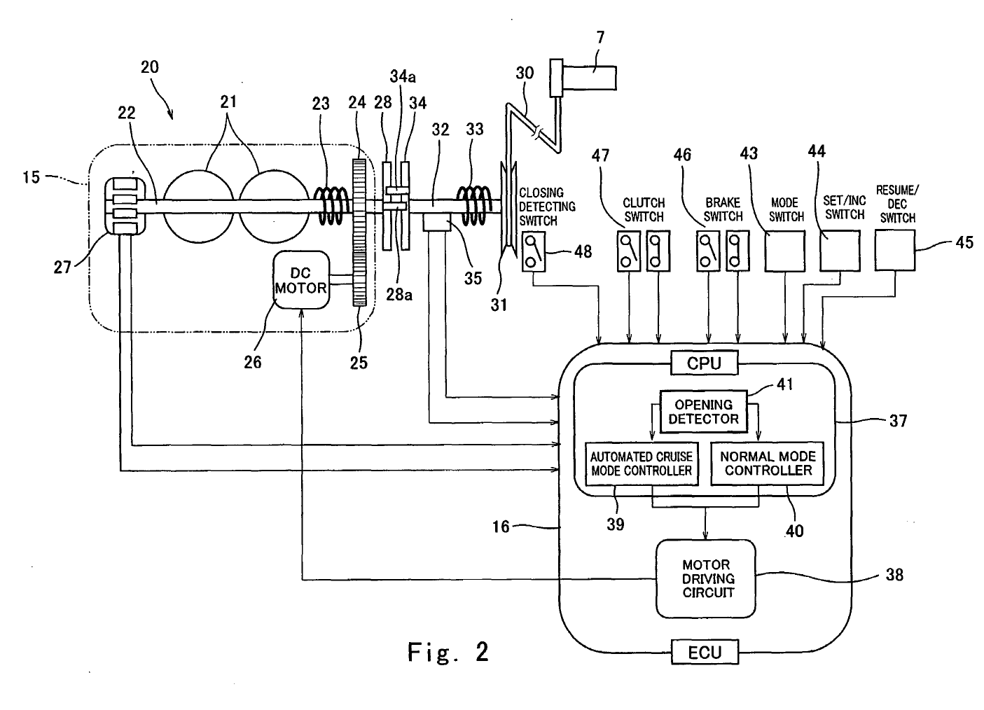

FIG. 1 is a left side view of a motorcycle 1 according to a first embodiment of the present invention. Turning now to FIG. 1, the motorcycle 1 includes a front wheel 2 and a rear wheel 3. The front wheel 2 is rotatably mounted to a lower end portion of a front fork 4 extending substantially vertically. The front fork 4 is mounted on a steering shaft (not shown) by an upper bracket (not shown) attached to an upper end thereof, and an under bracket (not shown) located under the upper bracket. The steering shaft is rotatably supported by a head pipe 5. A bar-type steering handle 6 extending rightward and leftward is attached to the upper bracket. A grip of the steering handle 6 which is configured to be gripped by the driver with a right hand is a throttle grip 7 (see FIG. 2) which is a input member configured to be rotated by rotation of a wrist of the driver to control a vehicle speed of the motorcycle 1. When the driver rotates the steering handle 6 clockwise or counterclockwise, the front wheel 2 is turned to a desired direction around the steering shaft 6.

A clutch lever 8 is attached in front of a grip of the handle 6 which is configured to be gripped by a left hand of the driver. A meter device 9 which displays a travel speed, an engine speed and other vehicle operating information, and has various switches associated with an automated cruise mode, is disposed in front of the handle 6. A pair of main frame members 10 extend rearward from the head pipe 5 to be tilted slightly downward. A pair of pivot frame members 11 are coupled to rear portions of the main frame members 10. A swing arm 12 is pivotally mounted at a front end portion thereof to the pivot frame member 11 and is configured to extend in a substantially longitudinal direction of the motorcycle 1. The rear wheel 3, which is a drive wheel, is rotatably mounted to a rear end portion of the swing arm 12. A fuel tank 13 is disposed behind the handle 6. A straddle-type seat 14 configured to be straddled by the driver is mounted behind the fuel tank 13.

Between the front wheel 2 and the rear wheel 3, the engine E is mounted on the main frame members 10 and the pivot frame members 11. A throttle body 15 is disposed inward of the main frame members 10 and is coupled to intake ports (not shown) of the engine E. An ECU (electronic control unit) 16, which is a controller, is accommodated in an inner space below the seat 14 to control the throttle body 15. An air cleaner box 17 is disposed below the fuel tank 13 and is coupled to an upstream side of the throttle body 15. The air cleaner box 17 is configured to take in fresh air by utilizing a wind pressure of the wind blowing from forward. A cowling 18 is mounted to extend from a front portion of the vehicle body to both sides of the vehicle body so as to cover the engine E and other components.

FIG. 2 is a block diagram of an electronic control throttle system 20 mounted in the motorcycle 1 of FIG. 1. As shown in FIG. 2, the electronic control throttle system 20 includes the known throttle body 15 provided therein with a butterfly-type throttle valve 21 which is configured to be opened and closed to control an amount of air taken in from outside and supplied to the engine E (see FIG. 1). The throttle valve 21 is fixed to a rotatable throttle shaft 22. A first return spring 23 is mounted on the throttle shaft 22. When driving power is not transmitted to the throttle shaft 22, the first spring 23 applies a force to return the throttle shaft 22 in a direction to close the throttle valve 21. A throttle position sensor 27 (throttle opening degree detector) 27 is attached on a left end portion of the throttle shaft 22 and is configured to detect a rotational angle (opening degree) of the throttle shaft 22. Instead of providing the throttle position sensor 27, the ECU 16 may serve as the throttle opening degree detector in such a manner that the ECU 16 controls a rotational speed of a DC motor 26 (actuator) to detect the rotational angle of the throttle shaft 22.

A first gear 24 is mounted on the throttle shaft 22. The throttle body 15 includes the DC motor 26. A second gear 25 is mounted on a drive shaft of the DC motor 26 and is in mesh with the first gear 24. In this state, a rotational driving force of the DC motor 26 is transmitted to the throttle shaft 22 via the second gear 25 and the first gear 24, causing the throttle valve 21 to be opened and closed. A throttle-shaft-side driven member 28 is mounted to a right end portion of the throttle shaft 22 so as to protrude in a flange shape radially outward from the throttle shaft 22.

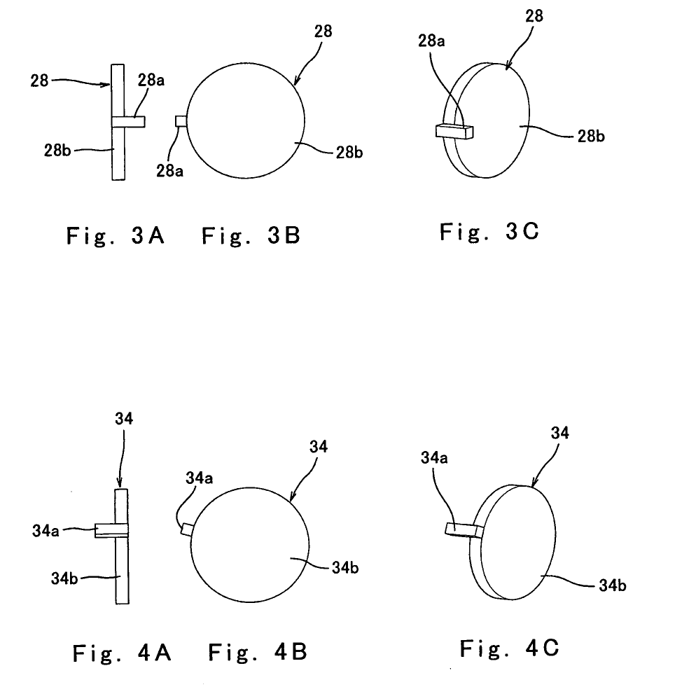

FIG. 3A is a front view of the throttle-shaft-side driven member 28 of the electronic control throttle system 20 of FIG. 2. FIG. 3B is a side view of the throttle-shaft-side driven member 28. FIG. 3C is a perspective view of the throttle-shaft-side driven member 28 of FIG. 2. As shown in FIGS. 2 and 3A and 3B, the throttle-shaft-side driven member 28 includes a circular-plate portion 28b protruding in a flange shape radially outward from the throttle shaft 22, and a support portion 28a protruding from a part of an outer peripheral end portion of the circular plate portion 28b toward a hand-operated-shaft-side driven member 34 to be described later. The circular-plate portion 28b and the support portion 28a form a unitary member. The support portion 28a is located in the direction to close the throttle valve 21 relative to a supported portion 34a of the hand-operated-shaft-side driven member 34 on a rotational track of the supported portion 34a.

As shown in FIG. 2, the electronic control throttle system 20 includes a hand-operated shaft 32 which is disposed coaxially of the throttle shaft 22 in such a manner that the hand-operated shaft 32 is not connected to the throttle shaft 22. A pulley 31 is fixed to a right end portion of the hand-operated shaft 32. A throttle cable 30 is coupled to the pulley 31 and is configured to operate in association with rotation of the throttle grip 7 (input member). The driver rotates the throttle grip 7 to rotate the hand-operated shaft 32 via the pulley 31. The hand-operated shaft 32 is attached with a grip position sensor 35 capable of detecting a rotational angle (opening degree) of the hand-operated shaft 32. A second return spring (biasing mechanism) 33 is mounted on the hand-operated shaft 32. The second return spring 33 applies a force to cause the hand-operated shaft 32 to be returned in the direction to close the throttle valve 21 under the state where the driving force of the throttle grip 7 resulting from the hand operation of throttle grip 7 performed by the driver is not transmitted to the throttle wire 30. The hand-operated-shaft-side driven member 34 is attached to a left end portion of the hand-operated shaft 32 such that the member 34 protrudes in a flange shape that is opposite to the throttle-shaft-side driven member 28.

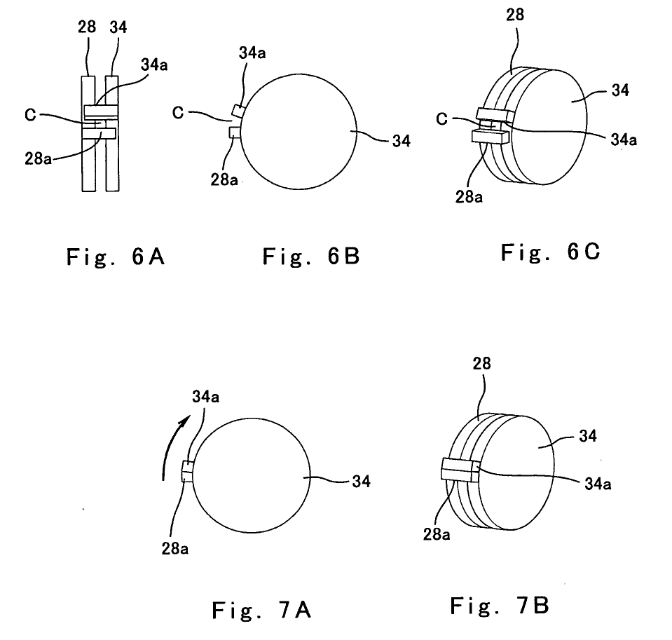

FIG. 4A is a front view of the hand-operated-shaft-side driven member 34 of the electronic control throttle system 20 of FIG. 2. FIG. 4B is a side view of the hand-operated-shaft-side driven member 34. FIG. 4C is a perspective view of the hand-operated-shaft-side driven member 34. As shown in FIGS. 2 and 4A and 4B, the hand-operated-shaft-side driven member 34 includes a circular-plate portion 34b protruding in a flange shape radially outward from the hand-operated shaft 22, and a supported portion 34a protruding from a part of an outer peripheral end portion of the circular plate portion 34b toward the throttle-shaft-side driven member 28 (see FIGS. 2 and 6). The circular plate portion 34b and the supported portion 34a form a unitary member. The supported portion 34a is located in the direction to open the throttle valve 21 relative to the support portion 28a on a rotational track of the support portion 28a.

As shown in FIG. 2, the electronic control throttle system 20 includes the ECU 16. The ECU 16 includes a CPU 37 having calculation and control abilities, a motor driving circuit 38 configured to drive the DC motor 26 and others. The CPU 37 includes an automated cruise mode controller 39, a normal mode controller 40, and an opening detector 41. The controllers 39 and 40 and the detector 41 of the CPU 37 are executed by suitably reading out associated control programs from a memory (not shown).

The automated cruise mode controller 39 is configured to execute an automatic driving mode in which the DC motor 26 is electronically controlled via the motor driving circuit 38 so that the engine E runs at a preset cruising engine speed. As used herein, the term “cruising engine speed” means an engine speed in which the motorcycle 1 is traveling at a preset cruising speed. The normal mode controller 40 is configured to execute a hand-operation driving mode in which an optimal target opening degree of the throttle valve 21 is calculated based on a detected value of the grip position sensor 35 considering a driving state of the motorcycle 1 and the like, and the DC motor 26 is electronically controlled so that a deviation between an opening degree detected by the grip position sensor 35 and a target opening degree is reduced.

The opening detector 41 is configured to detect that the throttle grip 7 has been operated in a direction to open the throttle valve 21 from a position corresponding to a cruising speed in the automated cruise mode. To be more specific, the opening detector 41 is configured to determine that the throttle grip 7 has been operated in the direction to open the throttle valve 21 from the position corresponding to the cruising speed when a difference between the opening degree detected by the grip position sensor 35 and the opening degree detected by the throttle position sensor 27 in the automated cruise mode is a predetermined value or more.

The meter device 9 (see FIG. 1) is attached with a selector-type mode switch 43, a press-button type SET/INC switch 44, and a press-button type RESUME/DEC switch 45. The driver operates the switches 43 to 45, which send signals input to the ECU 16. A brake (not shown) is provided with a brake switch 46 configured to detect whether or not the driver operated the brake. A clutch (not shown) is provided with a clutch switch 47 configured to detect whether or not the driver has operated the clutch. The electronic control throttle system 20 includes a closing detecting switch 48 (closing operation detector) configured to detect that the hand-operated shaft 32 is forcibly operated in the direction to close the throttle valve 21 by the operation of the throttle grip 7.

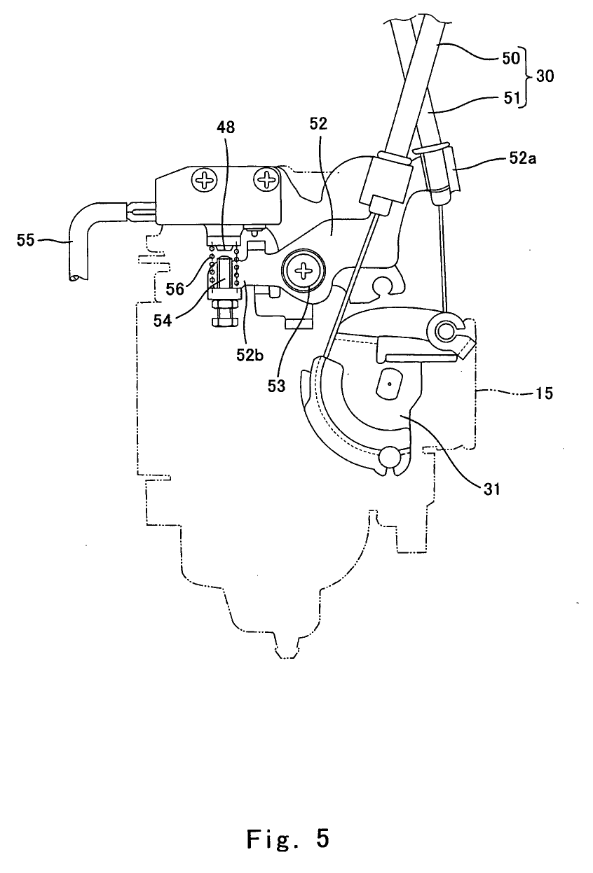

FIG. 5 shows a side view showing a region surrounding the closing detecting switch 48 of the electronic control throttle system 20 of FIG. 2. As shown in FIG. 5, the throttle cable 30 includes an opening cable 50 configured to rotate the pulley 31 in the direction to open the throttle valve 21 in association with the opening operation of the throttle grip 7 (see FIG. 2), and a closing cable 51 configured to rotate the pulley 31 in the direction to close the throttle shaft 21 in association with the closing operation of the throttle grip 7 (see FIG. 2). A pivot lever 52 is pivotally attached to an outer wall of the throttle body 15 such that the pivot lever 52 is pivotable around a pivot shaft 53. The closing cable 51 is coupled to one end portion 52a of the pivot lever 52, and a pin 54 which is a detected member is coupled to an opposite end portion 52b of the pivot lever 52. A tip end of the pin 54 is directed to face the closing detecting switch 48 which is a closing sensor fixed to the outer wall of the throttle body 15. The pin 54 is subjected to a force applied by a compressive spring 56 in a direction away from the closing detecting switch 48, i.e., in a direction opposite to the direction to close the throttle valve 21, in which the closing cable 51 moves via the pivot lever 52. When the throttle grip 7 (see FIG. 2) is operated to the fully closed position and thereby the closing cable 51 moves, the pin 54 moves to an advanced position via the pivot lever 52 to press the closing detecting switch 48, which sends a signal to the ECU 16 (see FIG. 2) via an electric wire 55. As the closing sensor, a non-contact sensor such as an optical sensor, which is configured to change an output signal according to a pivot amount of the pivot lever 52, may be used.

FIG. 6A is a front view showing a positional relationship between the throttle-shaft-side driven member 28 and the hand-operated-shaft-side driven member 34 in the normal mode. FIG. 6B is a side view showing a positional relationship between the throttle-shaft-side driven member 28 and the hand-operated-shaft-side driven member 34 in the normal mode. FIG. 6C is a perspective view showing the positional relationship between the throttle-shaft-side driven member 28 and the hand-operated-shaft-side driven member 34 in the normal mode. As shown in FIGS. 6A and 6B, in the normal mode, the rotation of the hand-operated-shaft-side driven member 34 resulting from the operation of the throttle grip 7 (see FIG. 2) performed by the driver is not transmitted to the throttle-shaft-side driven member 28, and the throttle shaft 22 (see FIG. 2) is driven by the DC motor 26 in response to a command from the ECU 16 (see FIG. 2). The supported portion 34a of the hand-operated-shaft-side driven member 34 is positioned so that a clearance C (play) is formed between the supported portion 34a and the support portion 28a of the throttle-shaft-side driven member 28. Therefore, if the throttle grip 7 (see FIG. 2) is quickly operated in the direction to close the throttle valve 21 in the normal mode, the rotation operation of hand-operated-shaft-side driven member 34 in the direction to close the throttle valve 21 is not impeded by the throttle-shaft-side driven member 28. To be more specific, since the throttle shaft 22 is electronically controlled by the ECU 16, it rotates with a delay of a slight response time after the hand-operated shaft 32 (see FIG. 2) rotates. But, because of the set clearance C, interference of the hand-operated-shaft-side driven member 34 with the throttle-shaft-side driven member 28 is avoided.

FIG. 7 is a side view showing a positional relationship between the throttle-shaft-side driven member 28 and the hand-operated-shaft-side driven member 34 in the automated cruise mode. As shown in FIG. 7, in the automated cruise mode, when the throttle grip 7 (see FIG. 2) is not operated, the hand-operated-shaft-side driven member 28 rotates in the direction to close the throttle valve 21 under the force applied by the second return spring 33 (see FIG. 2). Thereby, the supported portion 34a of the hand-operated-shaft-side driven member 34 is supported in contact with the support portion 28a of the throttle-shaft-side driven member 28, and in this state, the hand-operated shaft 32 (see FIG. 2) operates according to the rotation of the throttle shaft 22 (see FIG. 2). As a result, the throttle grip 7 (see FIG. 2) is kept in a position substantially corresponding to the cruising speed.

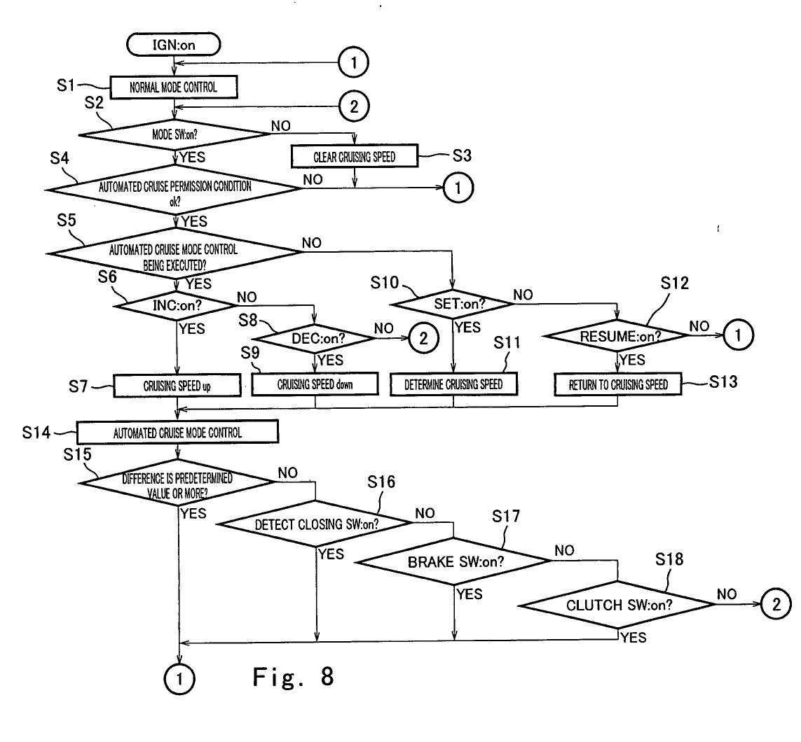

Subsequently, an operation of the electronic control throttle system 20 will be described. FIG. 8 is a flow chart showing the operation of the electronic control throttle system 20 of FIG. 2. As shown in FIGS. 2 and 8, when the ECU 16 detects that the ignition switch (not shown) has been turned ON, the electronic control throttle system 20 is controlled by the normal mode controller 40 of the ECU 16 to be in the normal mode (step S1). Then, the ECU 16 determines whether or not the mode switch 43 is in an ON-state (step S2). If it is determined that the mode switch 43 is in an OFF-state (NO in step S2), the cruising speed set by the automated cruise mode controller 39 is cleared (step S3). On the other hand, if it is determined that the mode switch 43 is in the ON-state (YES in step S2), the ECU 16 further determines whether or not a predetermined automated cruise permission condition is met (step S4). The automated cruise permission condition is set to a predetermined condition based on, for example, the vehicle speed, the gear position, etc.

If it is determined that the automated cruise permission condition is not met (NO in step S4), the ECU 16 returns the process to step S1. On the other hand, if it is determined that the automated cruise permission condition is met (YES in step S4), the ECU 16 determines whether or not the automated cruise mode control is being executed (step S5). If it is determined that the automated cruise mode control is being executed (YES in step S5), the ECU 16 determines whether or not the SET/INC switch 44 has been pressed (step S6). If it is determined that the SET/INC switch 44 has been pressed (YES in step S6), a set value of the cruising speed is increased according to the number of times the switch 44 has been pressed (step S7). Under this condition, the electronic control throttle system 20 is controlled by the automated cruise mode controller 39 of the ECU 16 to be in the automated cruise mode (step S14).

If it is determined that the SET/INC switch 44 has not been pressed (NO in step S6), the ECU 16 further determines whether or not the RESUME/DEC switch 45 has been pressed (step S8). If it is determined that the RESUME/DEC switch 45 has been pressed (YES in step S8), the ECU 16 decreases the set value of the cruising speed according to the number of times the switch 45 has been pressed (step S9), and the electronic control throttle system 20 is controlled by the automated cruise mode controller 39 to be in the automated cruise mode (step S14). On the other hand, if it is determined that the RESUME/DEC switch 45 has not been pressed (NO in step S8), the ECU 26 returns the process to step S2.

If it is determined that the automated cruise mode control is not being executed (NO in step S5), the ECU 16 determines whether or not the SET/SWITCH 44 has been pressed (step S10). If it is determined that the SET/INC switch 44 has been pressed (YES in step S10), the ECU 16 determines and sets a current vehicle speed as the cruising speed (step S11), and the automated cruise mode controller 39 of the ECU 16 starts the automated cruise mode control (step S14). If it is determined that the SET/INC switch 44 has not been pressed (NO in step S10), the ECU 16 further determines whether or not the RESUME/DEC switch 45 has been pressed (step S12). If it is determined that the RESUME/DEC switch 45 has been pressed (YES in step S12), the automated cruise mode control restarts at the cruising speed previously determined (steps S13 and S14). On the other hand, if it is determined that the RESUME/DEC switch 45 has not been pressed (No in step S12), the ECU 16 returns the process to step S1.

Then, the opening detector 41 of the ECU 16 determines whether or not a difference between the opening degree detected by the grip position sensor 35 and the opening degree detected by the throttle position sensor 27 is a predetermined value or more (step S15). If it is determined that the difference is the predetermined value or more (YES in step S15), the ECU 16 determines that the throttle grip 7 has been operated in the direction to open the throttle valve 21 from the position corresponding to the cruising speed, and returns the process to step S1 to execute the normal mode control. At this time, the supported portion 34a of the hand-operated-shaft-side driven member 34 is supported in contact with the support portion 28a of the throttle-shaft-side driven member 28, and in this state, the throttle grip 7 rotates according to the rotation of the throttle shaft 22. Therefore, when the driver operates the throttle grip 7 for acceleration and switches the automated cruise mode to the normal mode, the driver need not start rotating the throttle grip 7 from the fully closed position.

If it is determined that the difference in opening degree is less than the predetermined value (NO in step S15), the ECU 16 further determines whether or not the closing detecting switch 48 has been turned ON (step S16). In this case, since the supported portion 34a is supported by the support portion 28a, the pulley 31 does not move even when the throttle grip 7 is operated in the direction to close the throttle valve 21, whereas the end portion 52a of the pivot lever 52 rotates around the pivot shaft 53, and thereby the closing detecting switch 48 is turned ON. So, the ECU 16 returns the process to step S1 to execute the normal mode control. On the other hand, if it is determined that the closing detecting switch 48 is in the OFF-state (NO in step S16), the ECU 16 determines whether or not the brake switch 46 is in the ON-state (step S17).

If it is determined that the brake switch 46 is in the ON-state (YES in step S17), the ECU 16 returns the process to step S1 to execute the normal mode control. On the other hand, if it is determined that the brake switch 46 is in the OFF-state (NO in step S17), the ECU 16 further determines that the clutch switch 47 is in an ON-state (step S18). If it is determined that the clutch switch 47 is in the ON-state (YES in step S18), the ECU 16 returns the process to step S1 to execute the normal mode control. If it is determined that the clutch switch 47 is in the OFF-state (NO in step S18), the ECU 16 returns the process to step S2 to continue the automated cruise mode.

In accordance with the above described configuration, in the automated cruise mode, the throttle grip 7 operable in association with the rotation of the hand-operated hand 32 operates according to the rotation of the throttle shaft 22. Therefore, the driver need not start rotating the throttle grip 7 from the fully closed position when the driver operates the throttle grip 7 for acceleration and switches the automated cruise mode to the normal mode. Therefore, the difference in opening degree between the grip opening degree at which the driver starts rotating the throttle grip 7 and the grip opening degree at which acceleration actually starts is significantly reduced. This makes it possible to avoid acceleration that starts with a large time lag when the throttle grip 7 is operated to open the throttle valve 21 in the automated cruise mode. As a result, responsiveness of the motorcycle 1 to the operation of the throttle grip 7 is improved, improving the driver's comfort.

### Embodiment 2

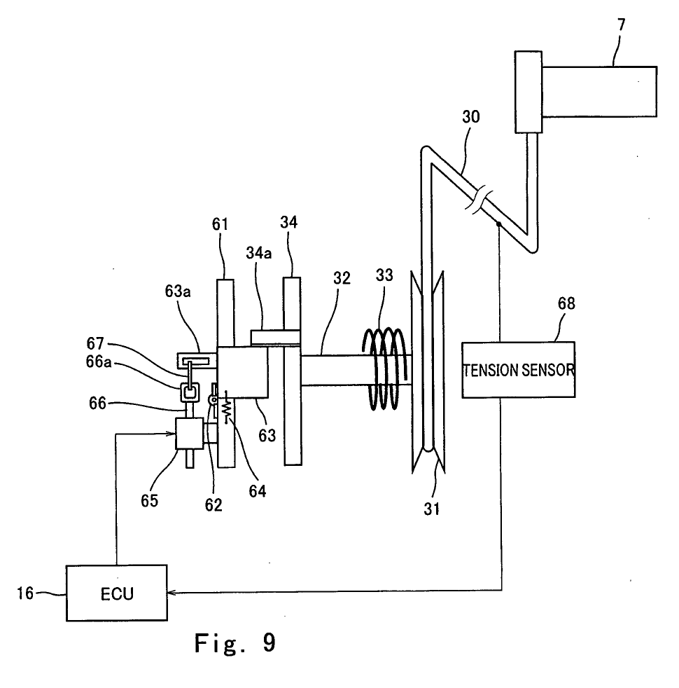

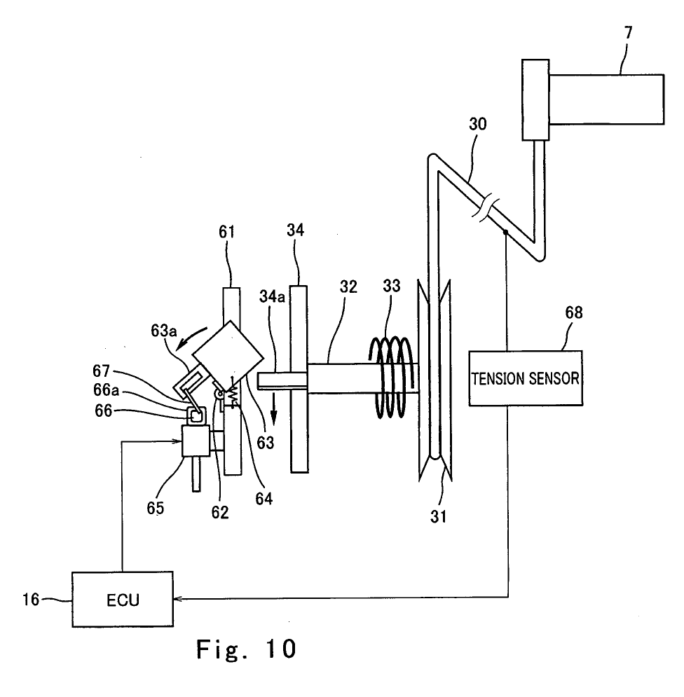

An electronic control throttle system according to a second embodiment will be described. FIG. 9 is a block diagram showing components of the electronic control throttle system according to the second embodiment of the present invention. The second embodiment differs from the first embodiment in that a support portion 63 of a throttle-shaft-side driven member 61 is retractable from a rotational track of the supported portion 34a of the hand-operated-shaft-side driven member 34. In FIG. 9, the same or corresponding components as those in the first embodiment are identified by the same reference numerals and will not be further described.

As shown in FIG. 9, the throttle-shaft-side driven member 61 has a circular-plate shape to protrude in a flange shape radially outward from a throttle shaft (not shown). The support portion 63 is rotatably mounted to the throttle-shaft-side driven member 61 by a hinge member 62. The support portion 63 is coupled to an outer peripheral portion of the throttle-shaft-side driven member 61 by a spring 64, and is subjected to a force applied by the spring 64 to be positioned in the direction to close the throttle valve 21 relative to the supported portion 34a of the hand-operated-shaft-side driven member 34 on the rotational track of the supported portion 34a of the hand-operated-shaft-side driven member 34. A first ring member 63a is mounted on the support portion 63 to protrude in the direction away from the supported portion 34a.

An electromagnetic solenoid 65 is attached to a side surface of the throttle-shaft-side driven member 61. A movable iron core 66 of the electromagnetic solenoid 65 protrudes toward the first ring 63a along a side surface of the throttle-shaft-side driven member 61. A second ring 66a is mounted on a tip end of the movable iron core 66 on the first ring 63a side. A coupling ring 67 is mounted between the first ring 63a and the second ring 66a.

A tension sensor (closing operation detector) 68 is coupled to the opening cable 50 (see FIG. 5) of the throttle cable 30 to detect a tension of the throttle cable 30. In the automated cruise mode, when a load is applied to the throttle grip 7 in the direction to close the throttle valve 21, the supported portion 34a of the hand-operated-shaft-side driven member 34 interferes with the supported portion 63 of the throttle-shaft-side driven member 61, causing the throttle grip 7 to be unable to rotate in the direction to close the throttle valve 21 (interference state), so that a larger tension than normal is generated in the throttle cable 30. The ECU 16 is configured to determine the interference state based on a signal from the tension sensor 68.

FIG. 10 is a block diagram showing the operation of the electronic control throttle system shown in FIG. 9. As shown in FIG. 10, in the automated cruise mode, when the driver operates the throttle grip 7 with a large force in the direction to close the throttle valve 21, the ECU 16 detects the interference state, and sends an operation signal to the electromagnetic solenoid 65. In addition, the ECU 16 switches the automated cruise mode to the normal mode. The movable iron core 66 of the electromagnetic solenoid 65 slides away from the first ring 63a and downward in FIG. 10, causing the second ring 66a, the coupling ring 67, and the first ring 63a to rotate the support portion 63. Thereby, the support portion 63 is retracted away from the rotational track of the supported portion 34a of the hand-operated-shaft-side driven member 34, enabling the supported portion 34a of the hand-operated-shaft-side driven member 34 to rotate without interference with the support portion 63 of the throttle-shaft-side driven member 61. The other configuration is identical to that of the first embodiment, and will not be further described.

### Embodiment 3

FIG. 11 is a perspective view showing components of an electronic control throttle system according to a third embodiment of the present invention. In FIG. 11, the same or corresponding components in the first embodiment are identified by the same reference numerals and will not be further described. As shown in FIG. 11, a throttle-shaft-side driven member 70, which is a pulley, is provided in a flange shape at an end portion of the throttle shaft 22. The throttle-shaft-side driven member 70 has a rod-shaped support portion 70a protruding toward a hand-operated-shaft-side driven member 73 to be described later. A drive pulley 71 is provided in a flange shape at an output shaft of the DC motor 26. A transmission belt 72 is installed around the drive pulley 71 and the throttle-shaft-side driven member 70 to be able to transmit a driving force therebetween.

The hand-operated shaft 32 is disposed coaxially with the throttle shaft 22. A hand-operated-shaft-side driven member 73 is provided at an end portion of the hand-operated shaft 32. The hand-operated-shaft-side driven member 73 is disposed to face the throttle-shaft-side driven member 70, and has an insertion hole 73b into which the rod-shaped support portion 70a is inserted. The insertion hole 73a is circular-arc shaped to allow the rod-shaped support portion 70a to be movable in the circumferential direction around the hand-operated shaft 32 within the insertion hole 73a. An end portion in the circumferential direction of the insertion hole 73a is a supported portion 73b configured to be supported by the support portion 70a in the automated cruise mode. The other configuration is substantially identical to that of the first embodiment, and will not be further described herein.

### Embodiment 4

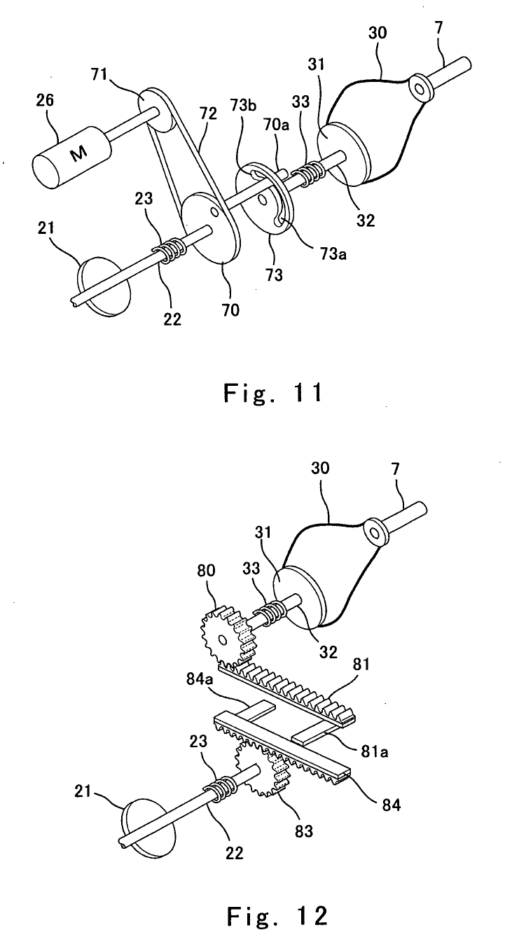

FIG. 12 is a perspective view showing components of an electronic control throttle system according to a fourth embodiment of the present invention. In FIG. 12, the same or corresponding components in the first embodiment are identified by the same reference numerals and will not be further described. As shown in FIG. 12, a hand-operated-shaft-side pinion gear 80 is provided at an end portion of the hand-operated shaft 32, and a hand-operated-shaft-side rack gear 81, which is a hand-operated-shaft-side driven member, is in mesh with the pinion gear 80. The hand-operated-shaft-side rack gear 81 has a supported portion 81a protruding toward a throttle-shaft-side rack gear 84 to be described later.

The throttle shaft 22 is placed substantially in parallel with the hand-operated shaft 32, and is provided at an end portion thereof with a throttle-shaft-side pinion gear 83. The throttle-shaft-side rack gear 84, which is a throttle-shaft-side driven member, is in mesh with the throttle-shaft-side pinion gear 83. The throttle-shaft-side rack gear 84 is substantially parallel to the hand-operated-shaft-side rack gear 81 and has a support portion 84a protruding toward the hand-operated rack gear 81. That is, the support portion 84a is positioned in the direction to close the throttle valve 21 relative to the supported portion 81a on an operation track of the supported portion 81a, and the supported portion 81a is configured to be supported by the support portion 81a in the automated cruise mode. The other configuration is substantially identical to that of the first embodiment, and will not be further described herein.

While in the above described embodiments, the motorcycle 1 has been illustrated, the electronic control throttle system 20 of the present invention is applicable to other vehicles such as all terrain vehicles (ATVs) or personal watercraft (PWC).

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An electronic control throttle system for a vehicle, comprising:
a throttle shaft configured to rotate a throttle valve for substantially opening and closing an air-intake passage connected to an engine;
a hand-operated shaft configured to rotate in association with a rotation of an input member configured to be operated by a driver driving the vehicle;
a biasing mechanism configured to apply a force to rotate the hand-operated shaft in a direction to close the throttle valve;
a hand-operated shaft-side driven member configured to operate in association with the rotation of the hand-operated shaft, the hand-operated-shaft-side driven member having a supported portion;
a throttle-shaft-side driven member which is provided to operate in association with the rotation of the throttle shaft, the throttle-shaft-side driven member having a support portion positioned in a direction to close the throttle valve relative to the supported portion on an operation track of the supported portion;
an actuator configured to cause the throttle shaft to rotate to open and close the throttle valve; and
a controller having an automated cruise mode for controlling the actuator to control an engine speed of the engine so that a travel speed of the vehicle becomes a preset cruising speed;
wherein in the automated cruise mode, the hand-operated shaft is subjected to a force in the direction to close the throttle valve and the supported portion is supported in contact with the support portion to cause the hand-operated shaft to operate according to the rotation of the throttle shaft.

2. The electronic control throttle system according to claim 1, further comprising:
a position sensor configured to detect a rotational angle of the hand-operated shaft; and
an opening detector configured to detect that the input member has been operated in a direction to open the throttle valve from a position corresponding to the cruising speed in the automated cruise mode;
wherein the controller has a normal mode for controlling the actuator based on a detected value of the position sensor, and is configured to, in the automated cruise mode, switch the automated cruise mode to the normal mode when the opening detector detects that the input member has been operated in the direction to open the throttle valve from the position corresponding to the cruising speed in the automated cruise mode.

3. The electronic control throttle system according to claim 2, further comprising:
a throttle opening degree detector configured to detect a rotational angle of the throttle shaft;
wherein the opening detector is configured to, in the automated cruise mode, determine that the input member has been operated in the direction to open the throttle valve from the position corresponding to the cruising speed, based on the rotational angle detected by the position sensor and the rotational angle detected by the throttle opening degree detector.

4. The electronic control throttle system according to claim 3,
wherein the opening detector is configured to, in the automated cruise mode, determine that the input member has been operated in the direction to open the throttle valve from the position corresponding to the cruising speed, when the rotational angle detected by the position sensor is a predetermined value or more larger than the rotational angle detected by the throttle opening degree detector.

5. The electronic control throttle system according to claim 1, further comprising:
a position sensor configured to detect a rotational angle of the hand-operated shaft;
wherein the controller has a normal mode for controlling the actuator based on a detected value of the position sensor;
wherein in the normal mode, the supported portion of the hand-operated-shaft-side driven member is provided to form a clearance in the direction to close the throttle valve relative to the support portion of the throttle-shaft-side driven member, between the supported portion and the support portion.

6. The electronic control throttle system according to claim 1, further comprising:
a position sensor configured to detect a rotational angle of the hand-operated shaft; and
a closing operation detector configured to detect that the input member has been operated in the direction to close the throttle valve in the automated cruise mode;
wherein the controller has a normal mode for controlling the actuator based on a detected value of the position sensor; and
wherein the controller is configured to switch the automated cruise mode to the normal mode when the closing operation detector detects that the input member has been operated in the direction to close the throttle valve.

7. The electronic control throttle system according to claim 6,
wherein the closing operation detector includes:
a throttle cable through which the rotation of the input member is transmitted to the hand-operated shaft;
a pivot lever to which the throttle cable is coupled;
a detected member provided on the pivot lever; and
a closing sensor having a detecting portion in a position where a distance between the detecting portion and the detected member is changed according to a pivot amount of the pivot lever, the closing sensor being configured to change an output signal according to the distance between the detecting portion and the detected member;
wherein the closing operation detector is configured to, based on the output signal from the closing sensor, detect that the input member has been operated in the direction to close the throttle valve.

8. The electronic control throttle system according to claim 6, further comprising:
a tension sensor configured to detect a tension of a throttle cable through which the input member and the hand-operated shaft are coupled to each other; and
wherein the closing operation detector is configured to detect that the input member has been operated in the direction to close the throttle valve when the tension detected by the tension sensor is a predetermined value or more.

9. The electronic control throttle system according to claim 1,
wherein the hand-operated shaft and the throttle shaft are disposed coaxially.

10. The electronic control throttle system according to claim 1,
wherein the hand-operated-shaft-side driven member is coupled integrally with the hand-operated shaft.

11. The electronic control throttle system according to claim 1,
wherein the throttle-shaft-side driven member is coupled integrally with the throttle shaft.

12. The electronic control throttle system according to claim 1,
wherein the hand-operated-shaft-side driven member is provided at an end portion of the hand-operated shaft and has a disc shape which is coaxial with a rotation center of the hand-operated shaft, and the throttle-shaft-side driven member is provided at an end portion of the throttle shaft and has a disc shape which is coaxial with rotation centers of the throttle shaft and the hand-operated-shaft-side driven member; and
wherein the hand-operated-shaft-side driven member and the throttle-shaft-side driven member are disposed to face each other to be spaced apart from each other.

13. The electronic control throttle system according to claim 1,
the support portion protrudes from the throttle-shaft-side driven member toward the hand-operated-shaft-side driven member, and the supported portion protrudes from the hand-operated-shaft-side driven member toward the throttle-shaft-side driven member and is positioned in a space which is located in a direction to open the throttle valve relative to the support portion.

14. The electronic control throttle system according to claim 13,
wherein the hand-operated-shaft-side driven member and the throttle-shaft-side driven member have a substantially equal diameter;
wherein the support portion and the supported portion are provided at outer peripheral portions of the throttle-shaft-side driven member and the hand-operated-shaft-side driven member, respectively; and
wherein one of the support portion and the supported portion extends to a location opposite to an outer peripheral surface of the throttle-shaft-side driven member or the hand-operated-shaft-side driven member at which the other of the support portion and the supported portion is provided.

15. The electronic control throttle system according to claim 1,
wherein the support portion of the throttle-shaft-side driven member is provided in a position except for a space which is located in a direction to open the throttle valve relative to the supported portion of the hand-operated-shaft-side driven member.

16. A vehicle equipped with an electronic control throttle system,
the electronic control throttle system including:
a throttle shaft configured to rotate a throttle valve for substantially opening and closing an air-intake passage connected to an engine;
a hand-operated shaft configured to rotate in association with a rotation of an input member configured to be operated by a driver driving the vehicle;
a biasing mechanism configured to apply a force to rotate the hand-operated shaft in a direction to close the throttle valve;
a hand-operated-shaft-side driven member configured to operate in association with the rotation of the hand-operated shaft, the hand-operated-shaft-side driven member having a supported portion;
a throttle-shaft-side driven member which is provided to operate in association with the rotation of the throttle shaft, the throttle-shaft-side driven member having a support portion positioned in a direction to close the throttle valve relative to the supported portion on an operation track of the supported portion;
an actuator configured to cause the throttle shaft to rotate to open and close the throttle valve; and
a controller having an automated cruise mode for controlling the actuator to control an engine speed of the engine so that a travel speed of the vehicle becomes a preset cruising speed;
wherein in the automated cruise mode, the hand-operated shaft is subjected to a force in the direction to close the throttle valve and the supported portion is supported in contact with the support portion to cause the hand-operated shaft to operate according to the rotation of the throttle shaft.

17. The vehicle according to claim 16, wherein the input member is a throttle grip or a throttle lever configured to be gripped by the driver driving the vehicle.
